(19) United States
(12) Patent Application Publication
(10) Pub. No.: US 2012/0307520 A1
(43) Pub. Date: Dec. 6, 2012

(54) INPUT DEVICE WITH LUMINOUS PATTERNS

(75) Inventor: Chung-Yuan Chen, Taipei (TW)

(73) Assignee: PRIMAX ELECTRONICS LTD., Taipei (TW)

(21) Appl. No.: 13/222,519

(22) Filed: Aug. 31, 2011

(30) Foreign Application Priority Data
Jun. 3, 2011 (TW) 100119530

(51) Int. Cl. F21V 8/00

(52) U.S. Cl. 362/606; 362/615

(57) ABSTRACT

The present invention discloses an input device with luminous patterns including an input interface and a backlight module. The backlight module includes a light source and a light guide plate. The light guide plate has a predetermined shading rate and at least one pattern formed on the bottom surface of the light guide plate. When the light source is turned off, the light passing through the light guide plate is too weak to show the pattern. When the light source is turned on, the luminous pattern is shown. The light guide plate is made from a mixture of transparent plastic particles and light absorption particles, and the pattern is formed of micro structures of light guide. The present invention provides the advantages of increasing the light source utilization rate, reducing costs, simplifying the manufacture process, improving the shading uniformity, reducing the thickness of input device and decreasing abrasion.

### FIELD OF THE INVENTION

The present invention generally relates to an input device, and more particularly to an input device with luminous patterns.

### BACKGROUND OF THE INVENTION

Applications of the touch input device is quite extensive. Currently, some of the touch input device which is commercially available has two kinds of different input modes simultaneously. Herein, the touch input device has a backlight module, and a first input mode is provided when the backlight module is turned on and thus the touch input device shows a predetermined pattern, while a second input mode is provided when the backlight module is turned off and thus the predetermined pattern is not shown. In another word, users may recognize which input mode it is switched to currently by whether the pattern is shown or not, and then input signals according to the current input mode. For example, when the backlight is turned off, an appearance of the touch input device is presented as a whole black state and the input mode is a mode for controlling a mouse cursor. Therefore, users can recognize that they can use the input device to implement motions of moving the mouse cursor and clicking after seeing the appearance is presented as the whole black state. On the contrary, when the backlight is turned on, a luminous keyboard is presented on the touch input device and the input mode is a mode for controlling a keyboard. Thus, users can recognize that they can use the input device to input letters or numbers, or implement other functions that can be provided by using a normal physical keyboard after seeing the luminous keyboard pattern. Therefore, one of the design points of such a backlight touch input device is how to ensure that the pattern is not shown when the backlight is turned off, but the luminous pattern is shown only when the backlight is turned on, so as to avoid confusing users.

FIG. 1 illustrates a side view of a conventional backlight input device. Referring to FIG. 1, the conventional backlight input device 1 comprises an input interface 11, a backlight module 12 and a Mylar plate 19 disposed bottom-up in sequence. Herein, the backlight module 12 comprises a light source 13 and a light guide plate 14, while a lower surface of the Mylar plate 19 is disposed with a plurality of patterns 17. The patterns 17 are printed by using a light transmissive black printing ink with a light shading rate about 98%, and the regions outside the patterns 17 are printed by using an opaque black printing ink to form a light shading layer 18. Therefore, the light can passes through the surface of the Mylar plate 19 from where printed with the patterns 17 only, but is unable to pass through from the regions outside the patterns 17. When the backlight module 12 of the backlight input device 1 is turned off, there is still faint light entering into the backlight input device 1 from the environment. However, the light quantity of the 2% faint light passing through the regions printed with the patterns 17 from the environment is too weak to be distinguished from that coming from the regions outside the patterns 17 by human eyes due to the light shading rate of the patterns 17 is 98%, and thus the patterns 17 would not be shown on the Mylar plate 19, i.e. users would not see the patterns 17. In contrast, when the backlight module 12 of the backlight input device 1 is turned on, there is a significant amount of light entering into the backlight input device 1, and thus a difference of the light quantities between the light passing through the regions printed with the patterns 17 and the light coming from the regions outside the patterns 17 is capable of being distinguished by human eyes although there is only 2% light passing through the Mylar plate 19, i.e. users can see the patterns 17.

FIG. 2 illustrates a side view of another conventional backlight input device 2. Referring to FIG. 2, the conventional backlight input device 2 comprises an input interface 21, a backlight module 22 and a surface layer 29 disposed bottom-up in sequence. An upper surface of the surface layer 29 is printed with a shading printing ink, so as to form a light shading layer 28 having a predetermined shading rate. The backlight module 22 comprises a light source 23 and a light guide plate 24. A lower surface 26 of the light guide plate 24 has at least a pattern 27 formed from micro structures of light guide arranged densely. Destruction of total reflection may occur due to incident angles of the light are capable of being varied by the micro structures of light guide in the light guide plate 24, and thus the light may be refracted to pass through the light guide plate 24. Therefore, when the light quantity in the light guide is sufficient, the light quantity reveals from the top side of the micro structures of light guide is enough to be distinguished by human eyes, and thus the pattern 27 is visible. When the backlight module 22 of the backlight input device 2 is turned off, the light quantity entering into the backlight input device 2 is not sufficient, and thus the pattern 27 would not be shown due to the light passing through the light shading layer 28 is not enough, i.e. users would not see the pattern 27. In contrast, when the backlight module 22 is turned on, the light passing through the light shading layer 28 via the micro structures of light guide is enough to show the luminous pattern 27.

However, both of the two conventional backlight input devices have restrictions in applications. For ensuring that the patterns 17 are not shown when the backlight module 12 is turned off, the conventional backlight input device 1 must use the light transmissive black printing ink with the light shading rate about 98% to print the patterns 17, and thus utilization efficiency of the backlight is only 2%. Therefore, the conventional backlight input device 1 must be equipped with the light source 13 using high brightness light emitting diodes (LEDs), and thus the use cost is increased. In addition, the light shading manners of both of the conventional backlight input device 1 and the conventional backlight input device 2 are disposing a Mylar plate 19 or a surface layer 29 over the light guide plate 24, and said Mylar plate 19 or surface layer 29 is coated with light shading materials on the surface thereof by a screen printing process. However, the screen printing process required being used for such light shading manners is complicated, and thus the fabricating cost is increased as well. Furthermore, the light shading materials coated on the surface of the Mylar plate 19 or the surface layer 29 are likely to fall off due to a long term use or wear and tear during transportation, and thus the life time of the backlight input device may be reduced. Accordingly, it is desired to provide a novel backlight input device to resolve the disadvantages of the conventional backlight input devices.

### SUMMARY OF THE INVENTION

The present invention is directed to an input device with luminous patterns, which has higher backlight utilization efficiency.

The present invention is also directed to an input device with luminous patterns, which is fabricated by a simpler process and thinner and lighter.

The present invention is further directed to an input device with luminous patterns, which is not likely to fall off due to a long term use or wear and tear during transportation.

The present invention is also directed to an input device with luminous patterns, wherein the light shading effect thereof is more uniform.

In a preferred embodiment, the present invention provides an input device with luminous patterns comprising:

an input interface; and

a backlight module, comprising:
a light source; and
a light guide plate, wherein the light guide plate has an upper surface and a lower surface, the lower surface of the light guide plate has at least a pattern, the light guide plate has a predetermined shading rate, and the at least a pattern is unable to be shown due to a brightness of the light guide plate is lower than the predetermined shading rate when the light source is turned off.

In a preferred embodiment, the light guide plate is doped with a plurality of light absorption particles, and thus the light guide plate has the predetermined shading rate.

In a preferred embodiment, the predetermined shading rate is between 75% and 80%.

In a preferred embodiment, the pattern is formed from a plurality of micro structures of light guide arranged densely.

In a preferred embodiment, the micro structures of light guide are a plurality of mesh points arranged densely.

In a preferred embodiment, the micro structures of light guide are a plurality of micro structures arranged densely.

In a preferred embodiment, the light source is disposed at a side surface of the light guide plate.

In a preferred embodiment, the input device further comprises a black base plate.

In a preferred embodiment, the input interface is a touch sensor.

In a preferred embodiment, the touch sensor is disposed above or under the backlight module.

In a preferred embodiment, the pattern is a button pattern.

In a preferred embodiment, the pattern is a keyboard pattern.

In a preferred embodiment, the pattern is a pattern of an interactive component.

### BRIEF DESCRIPTION OF THE DRAWINGS

FIG. 1 illustrates a side view of a conventional backlight input device.

FIG. 2 illustrates a side view of another conventional backlight input device.

FIG. 3 illustrates a side view of an input device with luminous patterns according to a first preferred embodiment of the present invention.

FIG. 4 illustrates an exemplary schematic view of a light guide plate of the present invention, which uses mesh points as micro structures of light guide.

FIG. 5 illustrates a schematic view of an input device with luminous patterns of the present invention when a light source is turned off.

FIG. 6 illustrates a schematic view of an input device with luminous patterns of the present invention when a light source is turned on.

FIG. 7 illustrates a side view of an input device with luminous patterns according to a second preferred embodiment of the present invention.

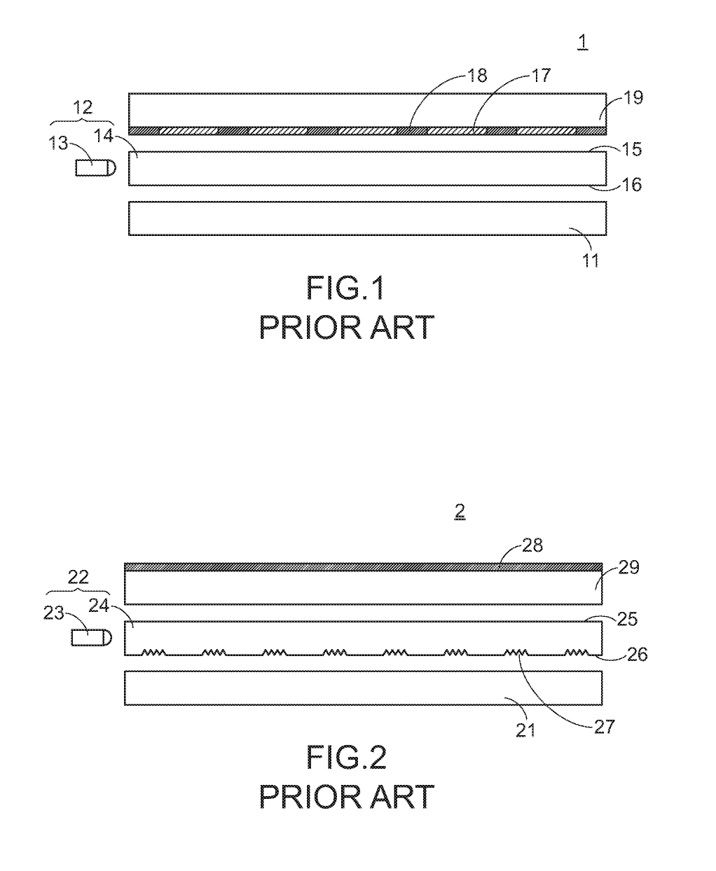

### DETAILED DESCRIPTION OF THE PREFERRED EMBODIMENT

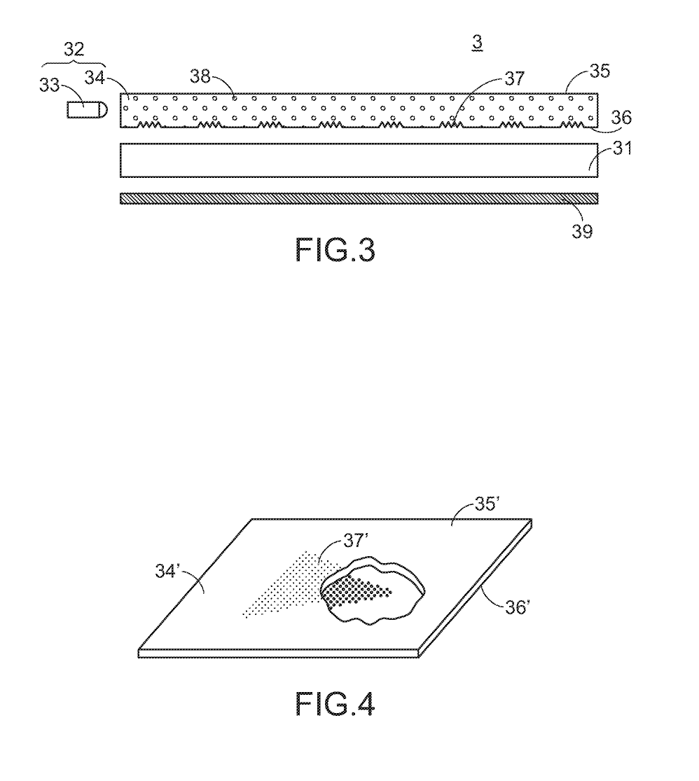

In view of the defects of the conventional arts, the present invention provides an input device with luminous patterns. FIG. 3 illustrates a side view of an input device with luminous patterns according to a first preferred embodiment of the present invention. Referring to FIG. 3, the input device 3 with luminous patterns comprises an input interface 31 and a backlight module 32. The backlight module 32 comprises a light source 33 and a light guide plate 34, wherein the light guide plate 34 has an upper surface 35 and a lower surface 36, and the lower surface 36 of the light guide plate 34 has at least a pattern 37 formed thereon. As illustrated in FIG. 3, the present embodiment illustrates a plurality of patterns, wherein each of the patterns 37 may be, for example, a function button (such as a pattern representing a power source button), a pattern representing a standard keyboard or a pattern representing an interactive component of an operating system (OS) of an input device (such as an application program icon displaying on a desktop). Preferably, the input device 3 of the present invention further comprises a black base plate 39 disposed under the input interface 31, wherein the input interface 31 is, for example, a touch sensor.

The light guide plate 34 of the present invention is formed from uniformly mixing transparent plastic particles with a plurality of light absorption particles 38 in a specific proportion first and then processed with an injection molding process, so as to let the light guide plate 34 have a predetermined shading rate and a uniform light shading result. In a preferred embodiment, the predetermined shading rate of the light guide plate 34 is from 75% to 80%. In addition, the lower surface 36 of the light guide plate 34 has a plurality of patters 37, and each of the patterns 37 is formed from a plurality of micro structures of light guide arranged densely. The micro structures of light guide of the present invention are formed from, for example, micro structures (such as micro lenses, v-cut.) arranged densely as illustrated in FIG. 3 or mesh points arranged densely as illustrated in FIG. 4. The micro structures of light guide for forming the patterns 37 (or 37′) are used for varying incident angles of a partial light inside the light guide plate 34 (or 34′), and thus the partial light may be refracted to pass through the light guide plate 34 (or 34′) due to the total reflection paths of the partial light are changed. Therefore, the light reveals from the top side of the micro structures of light guide, so as to present the luminous patterns 37 (or 37′).

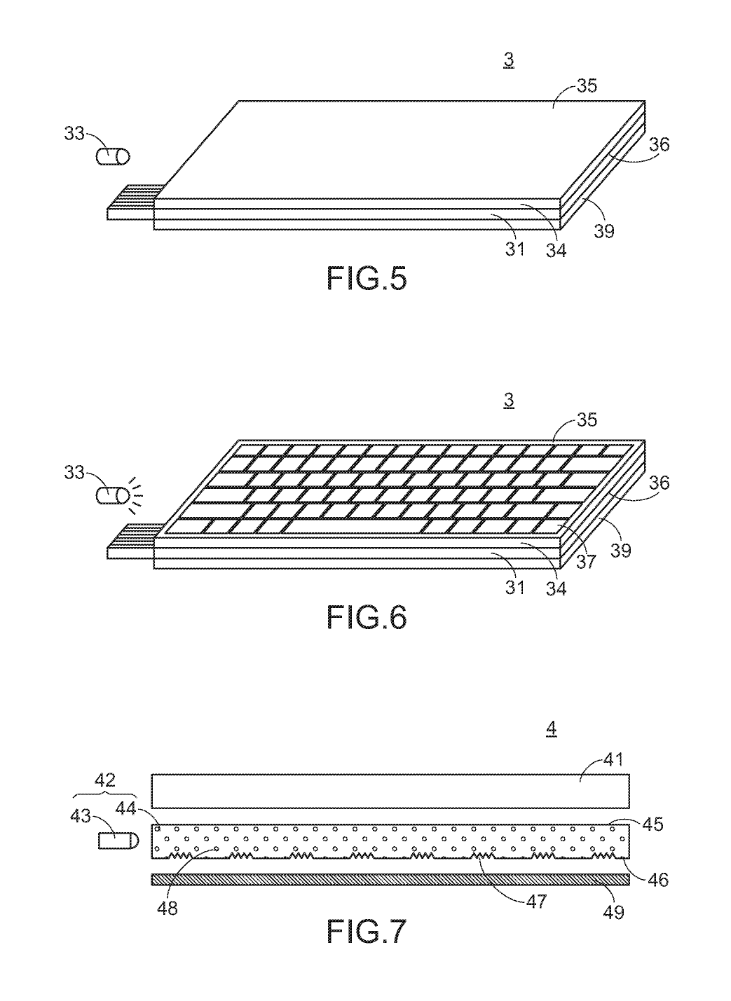

Referring to FIG. 5 and FIG. 6, FIG. 5 illustrates a schematic view of the input device 3 with luminous patterns as illustrated in FIG. 3 when the light source 33 is turned off, and FIG. 6 illustrates a schematic view of the input device 3 with luminous patterns as illustrated in FIG. 3 when the light source 33 is turned on. Referring to FIG. 5, when the backlight module 32 of the input device 3 is turned off, the light source is not provided by the input device 3, but only comes from the faint light in the ambient environment entering into the light guide plate 34 via the upper surface 35. In an instance of the predetermined shading rate of the light guide plate 34 being from 75% to 80%, there is 75% to 80% of the faint light entered into the light guide plate 34 being absorbed by the plurality of the light absorption particles 38, and the rest of light about 20% to 25% of the faint light is incident toward the lower surface 36 of the light guide plate 34 and reaches the micro structures of light guide of the lower surface 36 of the light guide plate 34. Since the light transmitted in different directions is incident to the micro structures of light guide with different incident angles, there is about a half of the light being refracted toward the lower surface 36 of the light guide plate 34, and thus there is only about 10% of the light being reflected toward the upper surface 35 of the light guide plate 34. The plurality of light absorption particles 38 within the light guide plate 34 are capable of absorbing some more light during the light being reflected, and thus there is only about 2% of the light quantity originally entered into the light guide plate 34 revealing from the top of light guide plate 34. Hence, the patterns 37 would not be presented from the top of light guide plate 34, i.e. users would not see the patterns 37. Certainly, the black base plate 39 in FIG. 3 is disposed for providing better light shading result when the backlight module 32 is turned off.

Referring to FIG. 6 as well, when the backlight module 32 is turned on and thus the light source 33 is turned on, a significant amount of light provided from the light source 33 enters into the light guide plate 34 from a side surface. Herein, the light out of the micro structures of light guide 37 is transmitted toward the upper surface 35 of the light guide plate 34 due to destruction of total reflection . In the instance of the predetermined shading rate of the light guide plate 34 being from 75% to 80%, there is about 75% to 80% of the light entered into the light guide plate 34 being absorbed by the plurality of the light absorption particles 38 in the light guide plate 34, and thus there is about 20% to 25% of the light passing through the light guide plate 34, so as to present the luminous patterns 37. Therefore, users can see the luminous patterns 37 as the keyboard pattern with a plurality of buttons as illustrated in FIG. 6.

It should be noted that for achieving the requirement of not to show the pattern 17 when the backlight is turned off, the conventional backlight input device 1 must choose the light transmissive black printing ink with the light shading rate about 98% to print the pattern 17, and thus most of the faint light entered into the backlight input device 1 from the environment is absorbed by the printing ink on the Mylar plate 19. Hence, only about 2% of the faint light remains to reveal from the top of the Mylar plate 19, and thus the pattern 17 is too dark to be distinguished by human eyes. However, the utilization efficiency of the backlight is only 2% when the light source is turned on due to the light transmissive rate of the light transmissive black printing ink used for printing the pattern is only 2%. Therefore, the conventional backlight input device 1 must be equipped with the light source with higher brightness, and thus the electric power consumption and the operation cost are increased. However, the light guide plate 34 of the present invention is formed by uniformly mixing the transparent plastic particles with the plurality of light absorption particles 38 first and then processed with the injection molding process, and the patterns 37 are formed from densely arranging the micro structures of light guide on the lower surface 36 of the light guide plate 34. In addition, the light quantity of the faint light is absorbed by the plurality of light absorption particles 38 during the faint light from the environment is entering into and reflected out of the light guide plate 34 respectively when the backlight is turned off. Furthermore, there is only remaining about a half of the light capable of being reflected toward and revealing from the top of the light guide plate 34 due to the light has different light incident angles. Hence, according to such design of the present invention, after the faint light in the environment entering into the input device 3, the light quantity is reduced continuously since the light is absorbed and reflected again and again during the light is transmitted. Therefore, as long as the light shading rate is about 80%, it is able to achieve the requirement of that not to show the patterns when the backlight is turned off, and the utilization efficiency of the backlight can reach about 20% when the backlight is turned on. Accordingly, it is able to achieve less power consuming, more power saving and much cost reducing by using the LEDs with lower brightness and lower cost. Moreover, according to the conventional backlight input device 2, the light shading printing ink is printed on the surface of another surface layer by the screen printing process, wherein the screen printing process needs to process a plurality of steps of screen plate fabrication comprising original screen plate fabrication, original screen plate cleanup, emulsion coating, plate burning, plate washout, imaging, and so on first, to put the imaged screen plate on the surface layer for scraping and printing thereafter, and then to process an air drying process. Therefore, not only the fabrication process is complicated, but also the shading printing inks are not likely to be printed uniformly due to problems of residue of shading printing inks, flatness of the scraper, flatness of the platform, solidness of the printing ink molecules, and so on, so as to generate a disadvantage of uneven light shading. In addition, the screen printing process can be used for printing the light shading materials on the surface of an object only and thus the light shading materials are likely to fall off due to a long term use or wear and tear during transportation. However, in the present invention, the light guide plate 34 is formed from uniformly mixing the transparent plastic particles with the plurality of light absorption particles 38 first and then processed with the injection molding process, so that it is able to reach advantages of not only lighter and thinner by replacing the surface layer with the light guide plate, but also significantly simplifying the process of combining with the light shading materials, reducing the unevenness of the distribution of the light shading materials, and avoiding the light shading materials fallen off due to a long term use or wear and tear during transportation.

The present invention further provides a second preferred embodiment. FIG. 7 illustrates a side view of an input device with luminous patterns according to a second preferred embodiment of the present invention. Referring to FIG. 7, the input device 4 with the luminous patterns comprises an input interface 41 and a backlight module 42. The backlight module 42 comprises a light source 43 and a light guide plate 44. The light guide plate 44 comprises a plurality of light absorption particles 48 and has an upper surface 45 and a lower surface 46. At least one pattern 47 is formed on the lower surface 46 of the light guide plate 44. Certainly, the input device 4 of the present embodiment may further be disposed with a black base plate 49. All the locations and the functions of each of the components in the second preferred embodiment are similar to those in the first preferred embodiment beside the backlight module 32 in the first preferred embodiment is located over the input interface 31, but the backlight module 42 in the second preferred embodiment is located under the input interface 41. Accordingly, it is able to dispose the relative position of the input interface and the backlight module properly according to the properties of the touch sensor and the light guide plate.

In summary, the input device with the luminous patterns of the present invention is improved according to the combination manner of the input device with the light shading materials and the utilization efficiency of the backlight. The light guide plate is formed by uniformly mixing the transparent plastic particles with the plurality of light absorption particles first and then processed with the injection molding process, so as to simplify the combination process of the backlight module with the light shading materials, to reduce the probability of distributing the light shading materials unevenly during the fabrication process, and avoid the light shading materials fallen off due to a long term use or wear and tear during transportation. Herein, when the light shading materials mixed uniformly to form the light guide plate with a lower predetermined shading rate is combined with the design of densely arranging the micro structures of light guide on light guide plate to form the patterns, not only the utilization efficiency of the backlight is significantly increased, but also the requirement of not to show the pattern when the backlight turned off is achieved. In addition, it is studied and thus found out that the most proper light shading rate of the input device with the luminous patterns fabricated by such a manner is about 75% to 80%. Therefore, it is able to not only achieve the requirement of not to show the pattern when the backlight is turned off, but also enhance the utilization efficiency of the backlight of the input device with the luminous patterns of the present invention to 20% to 25%, which is ten times to the utilization efficiency of the backlight of the conventional input device. In a word, the input device with the luminous patterns of the present invention is improved according to the combination manner of the input device with the light shading materials and the utilization efficiency of the backlight, so as to have the advantages of enhancing utilization efficiency of backlight, reducing cost, simplifying process, enhancing light shading uniformity and avoiding the light shading materials fallen off due to a long term use or wear and tear during transportation, and thus it is capable of enhancing overall value of industrial applications of the input device with the luminous patterns.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. An input device with luminous patterns, comprising:
an input interface; and
a backlight module, comprising:
a light source; and
a light guide plate, wherein the light guide plate has an upper surface and a lower surface, wherein the light guide plate is doped with a plurality of light absorption particles, and a pattern is disposed on the lower surface of the light guide plate, the light guide plate has a predetermined shading rate, and the pattern is unable to be shown when a brightness of the light guide plate is lower than the predetermined shading rate and the light source is turned off.

2. (canceled)

3. The input device with luminous patterns as claimed in claim 1, wherein the predetermined shading rate is between 75% and 80%.

4. The input device with luminous patterns as claimed in claim 1, wherein the pattern is formed from a plurality of micro structures of light guide arranged densely.

5. The input device with luminous patterns as claimed in claim 4, wherein the micro structures of light guide are a plurality of mesh points arranged densely.

6. The input device with luminous patterns as claimed in claim 4, wherein the micro structures of light guide are a plurality of micro structures arranged densely.

7. The input device with luminous patterns as claimed in claim 1, wherein the light source is disposed at a side surface of the light guide plate.

8. The input device with luminous patterns as claimed in claim 1, further comprising a black base plate.

9. The input device with luminous patterns as claimed in claim 1, wherein the input interface is a touch sensor.

10. The input device with luminous patterns as claimed in claim 9, wherein the touch sensor is disposed above or under the backlight module.

11. The input device with luminous patterns as claimed in claim 1, wherein the pattern is a button pattern.

12. The input device with luminous patterns as claimed in claim 1, wherein the pattern is a keyboard pattern.

13. The input device with luminous patterns as claimed in claim 1, wherein the pattern is a pattern of an interactive component.
